(19) United States
(12) Patent Application Publication
(10) Pub. No.: US 2016/0078197 A1
(43) Pub. Date: Mar. 17, 2016

(54) SPECIMEN FULFILLMENT ANALYTICS AND PROCUREMENT PROCESS

(71) Applicant: Novaseek Research LLC., Newton, MA (US)

(72) Inventors: Bennett Austin Malbon, JR., Newton, MA (US); Andrei Soran, Newton, MA (US); Ekaterina Vladimirovna Torchilin, Newton, MA (US)

(73) Assignee: Novaseek Research LLC., Newton, MA (US)

(21) Appl. No.: 14/849,507

(22) Filed: Sep. 9, 2015

Related U.S. Application Data
(60) Provisional application No. 62/100,827, filed on Jan. 7, 2015.
(60) Provisional application No. 62/049,857, filed on Sep. 12, 2014.

(51) Int. Cl. G06F 19/00

(52) U.S. Cl. CPC G06F 19/366; G06F 19/363

(57) ABSTRACT

A computer system automatically generates projected accrual rates for cohort definitions to assist researchers as they design cohorts for medical research projects. The projected accrual rates can help researchers to determine whether a particular cohort design is feasible for a particular research project, or if modifications may be necessary. The computer system also may automatically generate projected completion dates based on the projected accrual rates. The computer system can provide further assistance to researchers by automatically suggesting cohort criteria that may be relevant for a particular cohort design. For example, the computer system may generate a list of search results based on a search request, and provide a list of search results ordered by accrual rate. The computer system may assist a user in formulating such search requests by generating a suggested search term list.

### CROSS-REFERENCES TO RELATED APPLICATIONS

This application claims the benefit of U.S. Provisional Application No. 62/049,857, filed Sep. 12, 2014, and U.S. Provisional Application No. 62/100,827, filed Jan. 7, 2015, the disclosures of which are incorporated herein by reference.

### BACKGROUND

Access to high-quality biological specimens and clinical data remains a major bottleneck in advancing medical research. Ongoing studies may face difficulties in obtaining needed biological specimens from which test data will be generated, and the scope of future studies may be limited due to a lack of appropriate biological specimens. There is currently no easy way for the research community to obtain information about biological specimens that may be stored in biobanks across the country, or that may be discarded in hospital laboratories.

In addition, rich clinical data about patients often are not available, although such data is needed for discovery and development in the era of precision medicine. Identification of patients is one of the critical elements to advancing precision medicine—identifying the right patient at the right time for the right treatment. This is currently a very inefficient process and is a major cause of failure of clinical trials or identifying patients for the right treatment protocols, as well as a barrier to overall improvement in healthcare efficiency while controlling costs.

Yet, against this background of limited information, accurate cohort design aligned with real-world patient and specimen availability is still critical. Improvements in the area of analytics can have strong implications on how research cohorts are designed, and how fulfillment firms may customize specimen products and deal with specimen variety. Such improvements would provide the potential for increased productivity and decreased risk in research and development in a variety of fields, including pharmaceuticals, biotechnology, and diagnostics.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a computer system receives a request from a requester computing device, wherein the request comprises a cohort definition. The computer system performs a query on a centralized data repository comprising clinical data aggregated from a plurality of remote clinical data sources, based at least in part on the cohort definition. The computer system generates a projected accrual rate based at least in part on a result of the query, and transmits the projected accrual rate to the requester computing device for presentation in a user interface of the requester computing device.

The request also may include a matches-needed value. The computer system may generate a projected completion date based at least in part on the projected accrual rate and the matches-needed value.

The computer system may determine a projected accrual rate for a concurrent clinical term relationship in the cohort definition in order to generate the overall projected accrual rate. The computer system may weight the projected accrual rate for the concurrent clinical term relationship based on an age or sex requirement in the cohort definition.

In another aspect, the computer system receives a cohort criterion search request (e.g., from a requester computing device), generates a list of search results based on the search request, and provides a list of search results ordered by accrual rate. The computer system may assist a user in formulating such search requests by generating a cohort criterion search term list based on text input. The list of search results may be based on a query of aggregated clinical data, which may be pre-filtered based on patient consent.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a system diagram depicting an illustrative embodiment of a computer system that provides a fulfillment infrastructure with a related analytics platform according the present disclosure;

FIG. 2A is a screen shot of a cohort definition according to the present disclosure;

FIG. 2B is a screen shot of an illustrative user interface in which a cohort definition is provided in a cohort definition editor according to the present disclosure;

FIGS. 2C-2I are screen shots of illustrative user interfaces that may be used to define specific inclusion or exclusion criteria for cohort definitions according to the present disclosure;

FIG. 3 is a screen shot of a search box that may be presented as part of a user interface according to the present disclosure;

FIG. 4 is a screen shot of a search results interface that may be presented as part of a user interface according to the present disclosure;

FIG. 5 is a screen shot of a warning notification that may be presented as part of a user interface according to the present disclosure;

FIG. 6 is a screen shot of cohort feasibility information that may be presented as part of a user interface according to the present disclosure;

FIG. 7 is a table illustrating a pre-calculated concurrent clinical term relationship according to the present disclosure;

FIG. 8 is a flow chart illustrating a computer-implemented method according to an embodiment of the present disclosure; and

FIG. 9 is a block diagram illustrating aspects of an illustrative computing device appropriate for use in accordance with embodiments of the present disclosure.

### DETAILED DESCRIPTION

The present disclosure describes a novel approach to analytics within a fulfillment infrastructure that provides technical solutions to technical problems, including particular solutions for cohort decision support and cohort feasibility analysis, which may be especially useful in the field of medical research. With regard to cohort decision support, the present disclosure describes informing requesters (e.g., researchers) as to historical frequency of occurrence of specific cohort criteria in a real-world patient population for purposes of designing a research cohort. With regard to cohort feasibility analysis, the present disclosure describes identifying meaningful patterns in data to form predictive statements regarding availability of patients and specimens with specifically requested clinical and demographic characteristics.

In the following description, numerous specific details are set forth in order to provide a thorough understanding of illustrative embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein. The illustrative examples provided herein are not intended to be exhaustive or to limit the claimed subject matter to the precise forms disclosed.

For ease of discussion and illustration, the present disclosure uses terms such as “analyze,” “normalize,” “aggregate,” and “query” as high-level terms for operations performed by a computer, and should not be confused with acts performed by a human being unless explicitly stated otherwise. The lower-level computer operations corresponding to these terms may vary depending on, for example, the type of computing device and operating system being used, software or hardware design considerations, and/or other factors.

The present disclosure includes several novel aspects. In one aspect, a computer system hosts a centralized data repository and a cohort analytics platform. The centralized data repository contains both historic and continuously updated data relating to specimens and patients from multiple source sites (e.g., hospital central labs, ambulatory providers, and third-party biobanks). This data is aggregated into a virtual pool that is much larger than any single source site can provide on its own, and allows the capture of specimens that may only be temporarily available at the source sites before being discarded.

The aggregated data is used to predict the availability and accrual rate of requested patients and specimens. The data can be updated in real-time or near real-time, allowing identification of consenting patients who fit clinical criteria and allowing researchers the potential to approach such patients for research studies. The centralized data repository improves upon a federated approach in which multiple data sources must be separately queried. The centralized data repository allows for faster, more meaningful analytics, which can in turn help to create more meaningful insights in terms of cohort decision support and cohort feasibility, and to better identify patients and/or specimens that match a cohort.

In designing a study, researchers may define characteristics of patients and patient cohorts (e.g., to compare patients that have a disease with similar patients that do not) that are needed for the study, e.g., for biomarker discovery or clinical studies or clinical trials. Historically, this information has been hard to obtain for researchers.

In embodiments disclosed herein, a cohort analytics platform provides analytics functionality that can be helpful in cohort design. To achieve this, the cohort analytics platform can perform analytic functions based on database queries. For example, the cohort analytics platform can calculate frequency of historically available matching patients and specimens, and use such calculations to guide cohort design and predict the future availability of similar patients and specimens. The cohort analytics platform also may perform analytic functions without accessing a database. For example, the cohort analytics platform may use a probability density function to calculate the probability that a future lab result will be in a particular range, as described in detail below. The cohort analytics platform may analyze search criteria (e.g., by a assigning a score to the criteria, identifying particular problems with the criteria such as low accrual rates, etc.). Such analysis can help to highlight limiting factors and make recommendations to the researcher to help improve their design, such as by increasing an expected accrual rate.

Longitudinal data (including Protected Health Information (PHI)) may be used from patients with multiple encounters. In an illustrative usage scenario, the centralized data repository collects patient data, including PHI such as service dates and record identifiers, in accordance with HIPAA. The cohort analytics platform is able to detect and correlate data from multiple encounters for the same patient. Thus, the cohort analytics platform can apply analytics to longitudinal patient data and allow for longitudinal specimen collections, such as subscribing to specimens from specific donors.

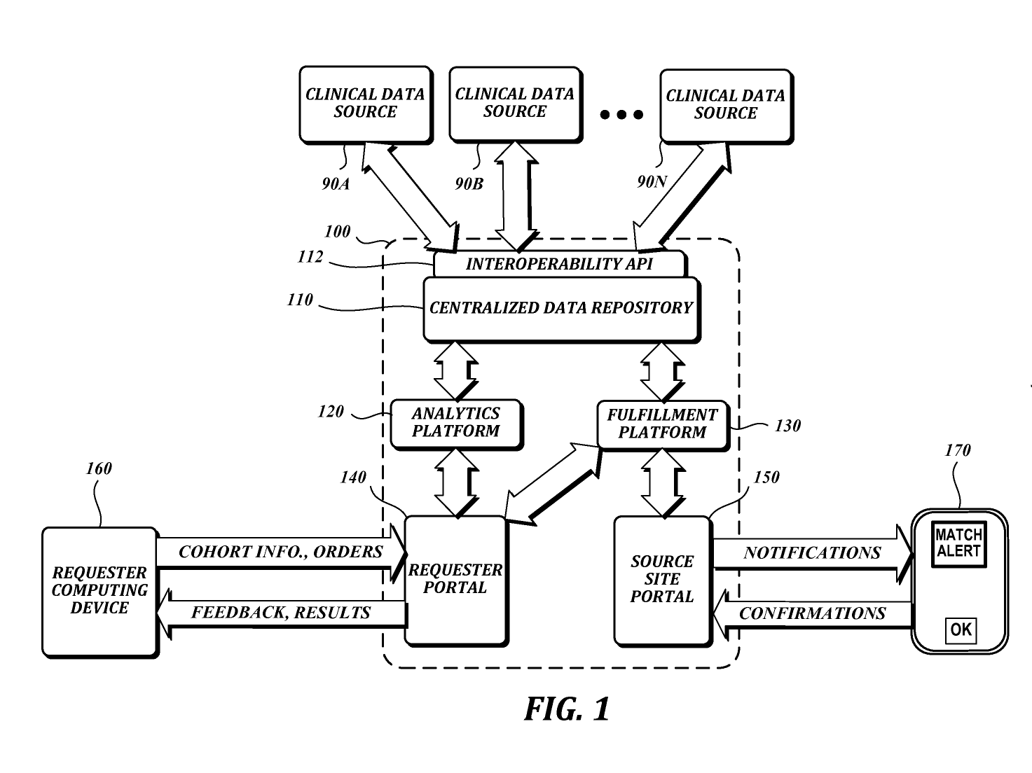

FIG. 1 is a system diagram depicting an illustrative embodiment of a computer system that provides a fulfillment infrastructure according to the present disclosure. In the example shown in FIG. 1, a computer system 100 hosts a centralized data repository 110 that receives clinical data from several clinical data sources 90A-90N via a network (not shown), such as the Internet. The centralized data repository 110 exposes, in this example, an interoperability API (application programming interface) 112 that allows the various data sources 90A-90N to provide the clinical data without requiring burdensome modifications of the clinical data at the data sources. The centralized data repository 110 improves upon a federated approach in which multiple data sources must be separately queried.

The clinical data may be available electronically in a variety of data formats, and may include forms that comply with HL7® standards (promulgated by Health Level Seven International), flat file documents, or continuity of care documents (CCDs). Data integrations can be tailored to take input data from each source site. An integration platform (not shown) can be used to standardize the data format and normalize all coded data (e.g., to common dictionaries), and prepare the data for further processing. Data can be encrypted for security purposes. For example, data can be encrypted in transit between the clinical data sources 90A-90N and the centralized data repository 110 via a virtual private network (VPN) with restricted port-specific access.

The clinical data includes information that may be useful for finding matches for requests, which may include information such as demographics (e.g., age, sex, race, ethnicity, geography), comorbidities (e.g., chronic and current conditions, when diagnosed); medications (e.g., type, frequency of dose, dosage amount, route, when prescribed); procedures (e.g., type, when performed); lab results (e.g., type of test, value, when tested); physician information (e.g., referring, admitting, and/or consulting physicians); and any other information that may be available or become available in hospitals and may be needed or useful for finding matches for requests. The clinical data may include coded information, structured information, or unstructured information, which may exist as free text, notes, or the like.

For requests for potential clinical trial subjects or precision medicine patients, such information may be associated with a patient profile, which may be anonymized to preserve patient privacy. For specimen requests, such information also may be associated with a specimen identifier along with other specimen information (e.g., specimen type, date, etc.), along with a patient profile.

The clinical data sources 90A-90N may be associated with one or more source sites (e.g., hospitals, ambulatory providers, or biobanks). The clinical data sources 90A-90N may include repositories that employ specialized information management systems, such as LIMS (laboratory information management systems). A single source site may provide one or more of the clinical data sources 90A-90N from within its facility or organization.

Source sites may obtain consent and authorization from patients, e.g., in the form of signed consent and authorization forms, which may be approved by an institutional review board (IRB). Consents and patient data may be collected prospectively, e.g., before actual specimens are obtained, at the point of admission or registration. Consent status can be captured electronically for each patient (e.g., by scanning a paper form, extracting status from a web-based form, etc.). Consent status can then be used to filter data sent by a source site to the centralized data repository 110 to ensure that only data from patients who have explicitly granted consent and authorization to participate is received.

In the example shown in FIG. 1, the computer system 100 also hosts an analytics platform 120 and a fulfillment platform 130. The computer system also provides a requester portal 140 that interacts with the analytics platform 120 and the fulfillment platform 130, and a source site portal 150 that interacts with the fulfillment platform 130. Access to the various functionality of the requester portal 140 and the source site portal 150 can be provided, for example, by web browsers or dedicated applications running on requester computing devices or source site computing devices.

As shown in FIG. 1, a requester computing device 160 interacts with the computer system 100 via the requester portal 140. A requester computing device 160 is a computing device of any suitable configuration or form factor, such as a desktop computer, notebook computer, tablet computer, or smart phone. In an illustrative embodiment, a user (e.g., a researcher) of the requester computing device 160 interacts with the requester portal 140 via a web browser that provides a user interface through which the user can make requests for biological specimens, patients for participation in clinical trials, or the like, as described in further detail below. Although only one requester computing device 160 is shown for ease of illustration, it should be understood that more than one, and potentially hundreds or thousands of requester computing devices may be accommodated.

At a basic level, the requester portal 140 provides an interface between requester computing devices and the computer system 100. However, the requester portal 140 may provide many other features in addition to this basic functionality.

For example, in one embodiment, the requester portal 140 includes several sections, including analytics, orders, and account management or administrator sections. These sections are only examples, and the actual number of sections and functionality of specific sections may vary depending on implementation. The analytics section of the requester portal 140 may provide access to the analytics platform 120, which provides researchers with tools to predict availability and accrual rate of desired samples and cohorts. The analytics platform 120 also can give researchers insight into feasibility and an expected timeline as they are creating orders. Further details relating to the analytics platform and related tools are provided below.

In the example shown in FIG. 1, a source site computing device 170 interacts with the computer system 100 via the source site portal 150. A source site computing device 170 may be a computing device of any suitable configuration or form factor, such as a desktop computer, notebook computer, tablet computer, or smart phone.

In an illustrative embodiment, a user (e.g., a lab technician) of the source site computing device 170 interacts with the source site portal 150 via a web browser that provides a user interface through which the user can receive notifications of potential matches for requests for biological specimens, patients for participation in clinical trials, or the like. Preferably, the source site computing device 170 is a tablet computer or other mobile computing device that can be easily carried by a lab technician or other personnel that may respond to such notifications. The source site computing device 170 receives a notification (e.g., via fax, email, instant message, SMS, push notification, etc.) when there is an actionable match.

Although only one source site computing device 170 is shown for ease of illustration, it should be understood that more than one, and potentially hundreds or thousands of source site computing devices may be accommodated. The source site computing device 170 can be a dedicated device that is specifically programmed to only allow access to the source site portal 150 and related functionality. A dedicated device may be, for example, a special-purpose device that lacks some functionality that may ordinarily be present on a general-purpose computing device, or a general-purpose device with other functionality (e.g., general Internet access) included but disabled. As an example, a special-purpose device may provide notifications and access to the source site portal 150 via a dedicated software application or specially modified web browser, rather than a general-purpose web browser.

At a basic level, the source site portal 150 provides an interface between source site computing devices and the computer system 100. However, the source site portal 150 may provide many other features in addition to this basic functionality. For example, in one embodiment, the source site portal 150 transmits a notification to one or more source site computing devices 170 associated with a source site when there is a matching specimen identified in their facility. For example, referring to the source site computing device 170 shown in FIG. 1, a user may click or tap a “Match Alert” notification to obtain additional information about the match, and confirm receipt of the notification by clicking or tapping on the “OK” button, which may generate a confirmation to be transmitted back to the computer system 100.

Many alternatives to the arrangement depicted in FIG. 1 are possible. For example, a computer system dedicated to analytics may host the analytics platform 120, but not the fulfillment platform 130, which may be hosted by a different computer system. As another example, some functionality that is described as being provided by the computer system 100, such as functionality associated with the requester portal 140, may instead be provided directly by software installed on a suitably programmed requester device. As another example, in the arrangement shown in FIG. 1, the source site portal 150 provides access to the fulfillment platform 130, but not the analytics platform 120. However, alternative designs are possible in which the source site portal 150 provides access to the analytics platform 120. For example, it may be desirable to allow source sites to use the analytics platform 120 to determine, for example, whether there is a surplus or shortage to which they may be able to respond by decreasing or increasing efforts, respectively, to obtain corresponding specimens.

### Cohort Analytics Platform

Additional details of an illustrative analytics platform will now be described. The illustrative analytics platform is a cohort analytics platform that provides cohort analytics in two parts: a decision support service and a feasibility analysis service. When combined, these features create a powerful platform for researchers to design cohorts for research projects that attempt to match real-world patient populations, such as specimen procurement projects or clinical trial recruitment projects.

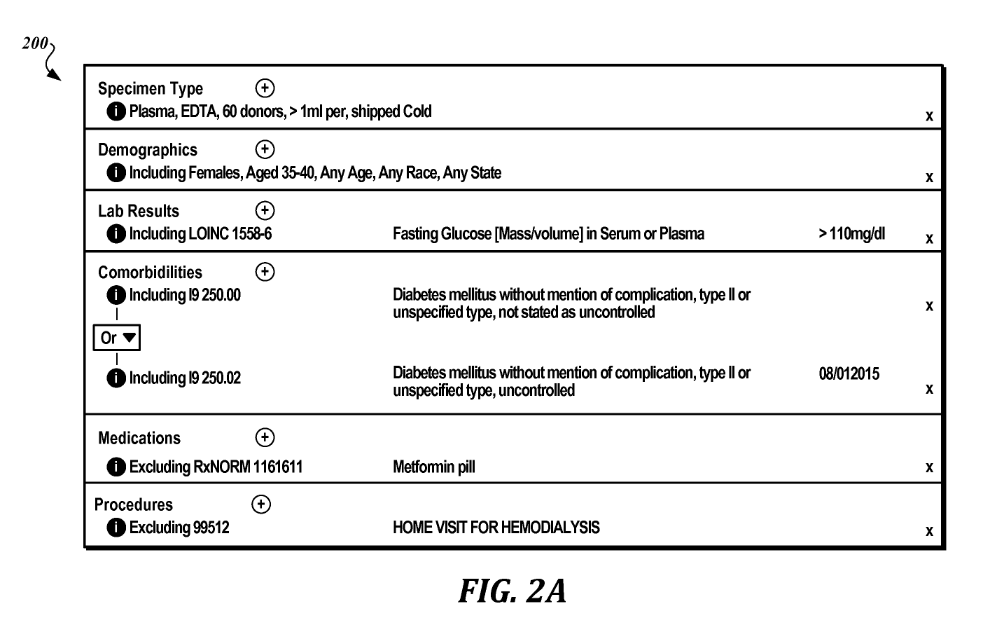

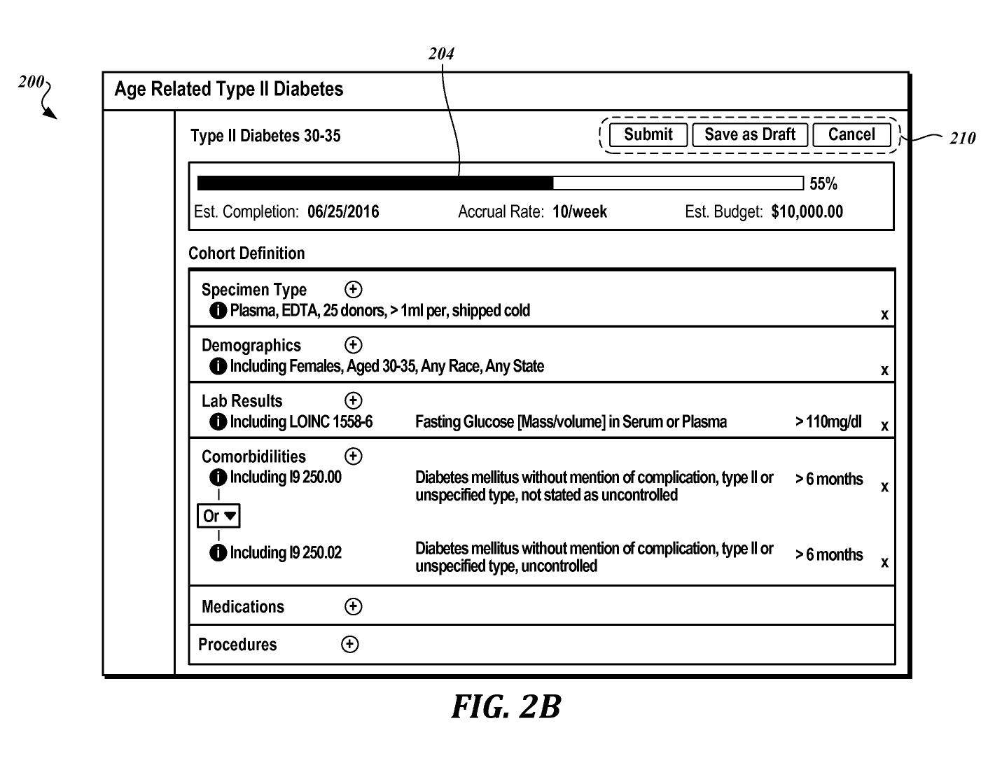

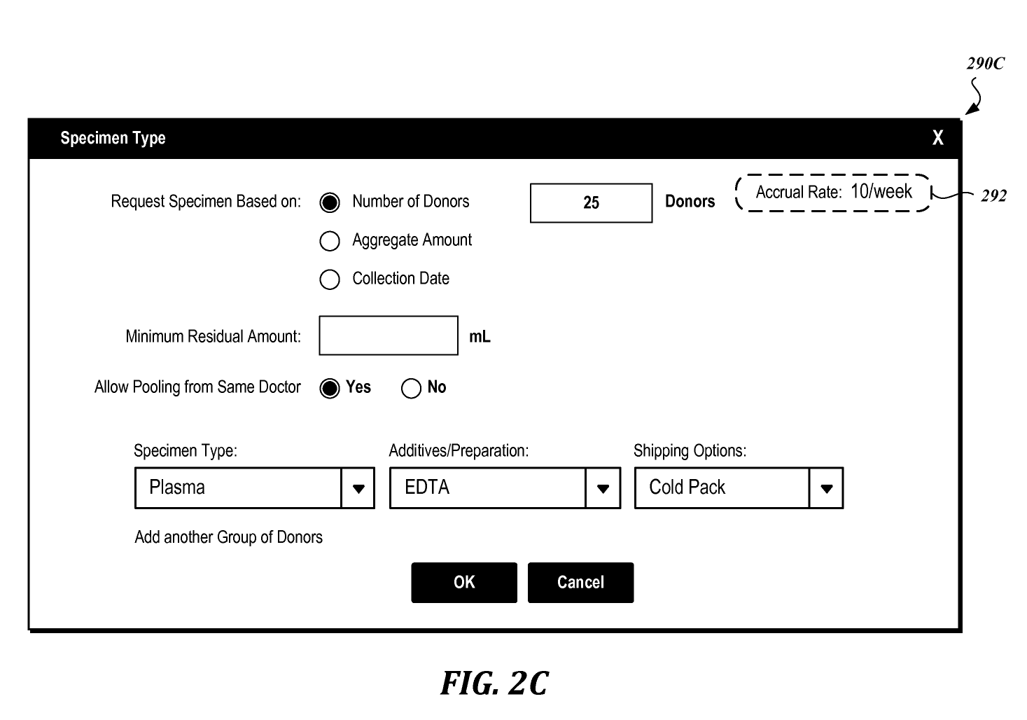

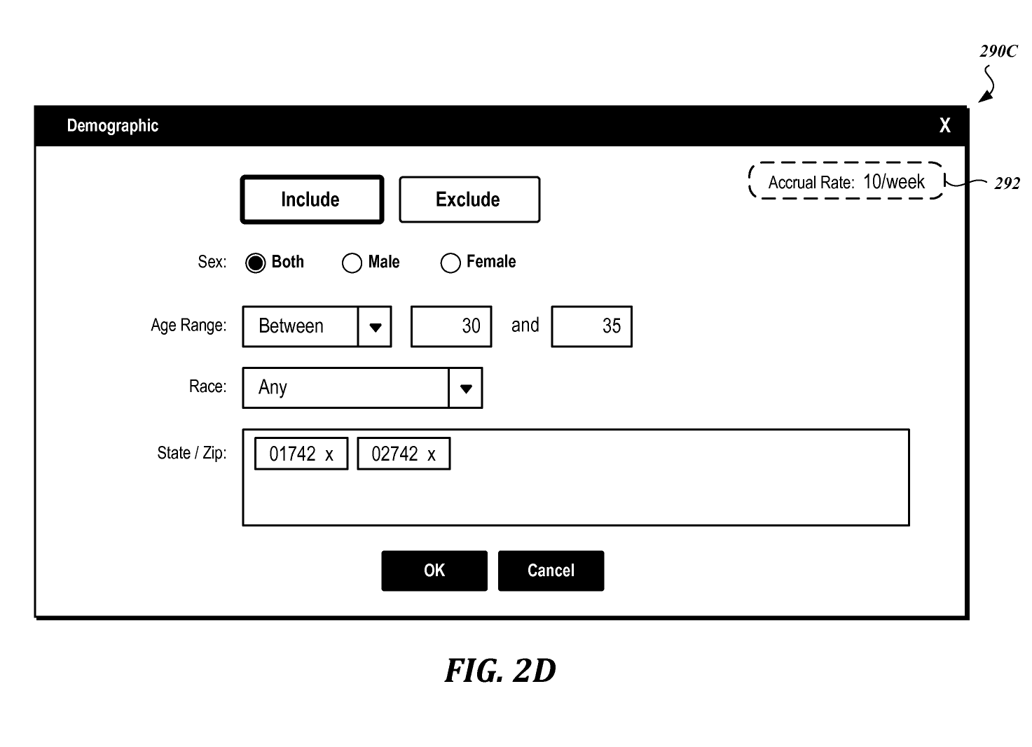

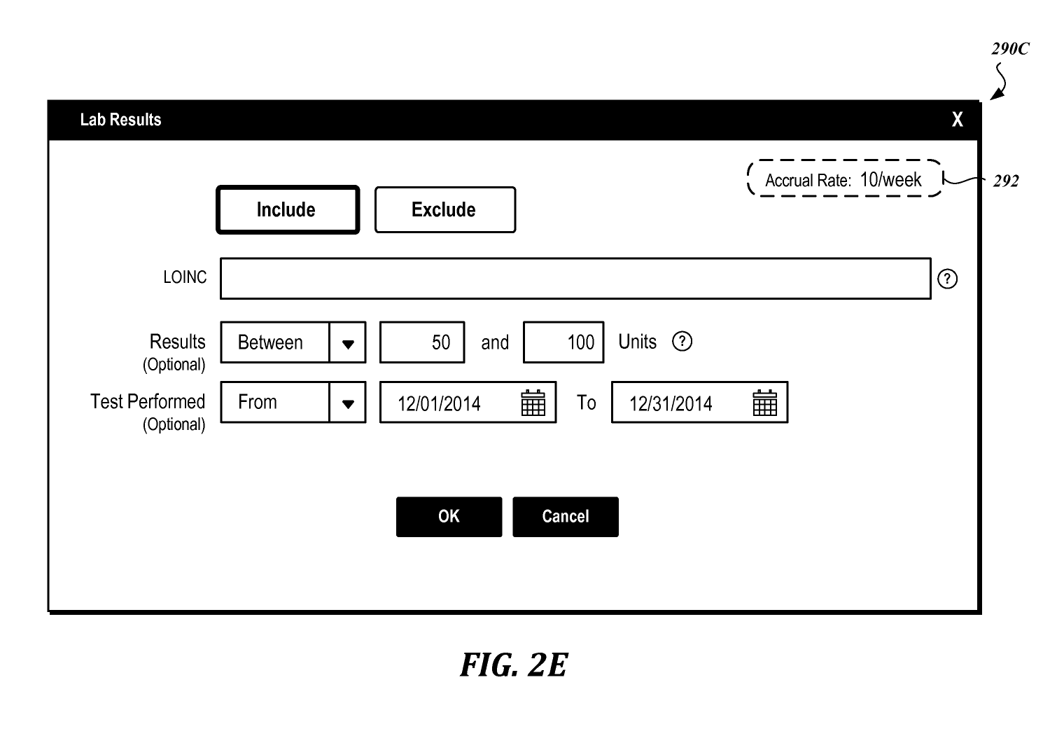

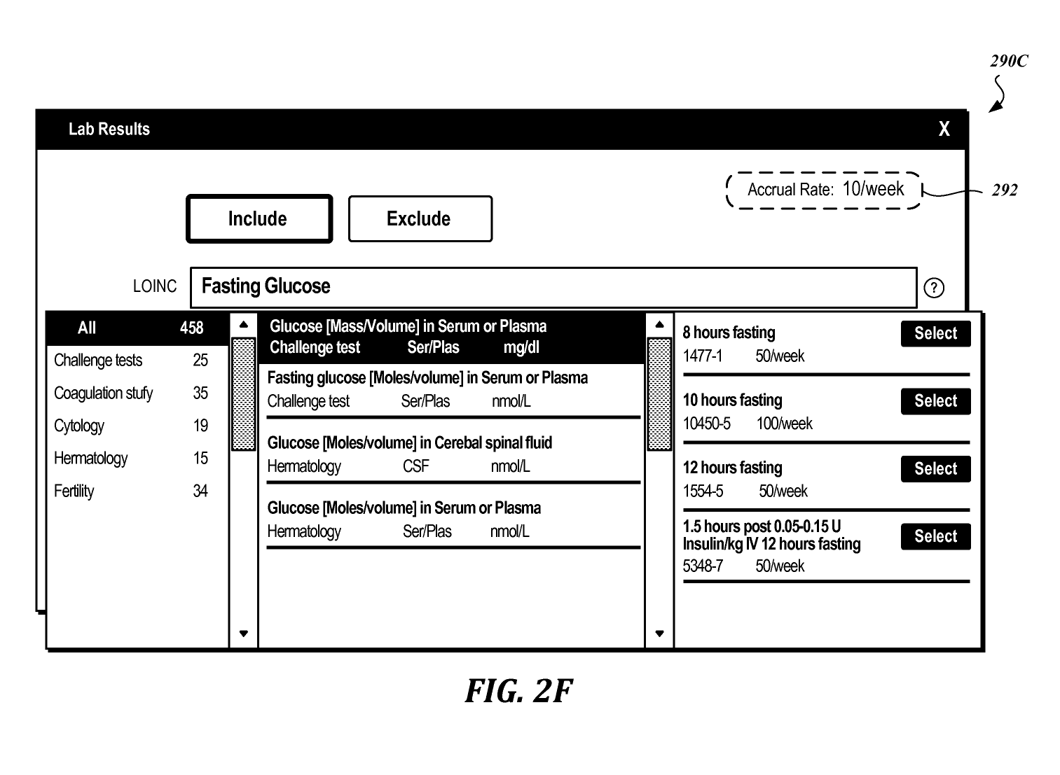

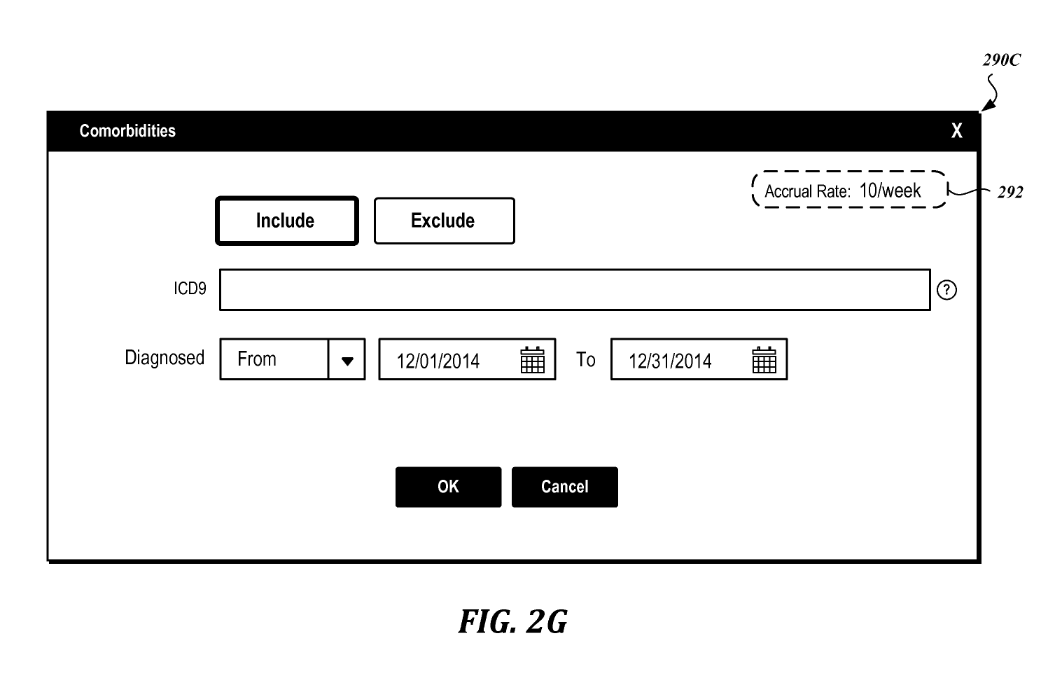

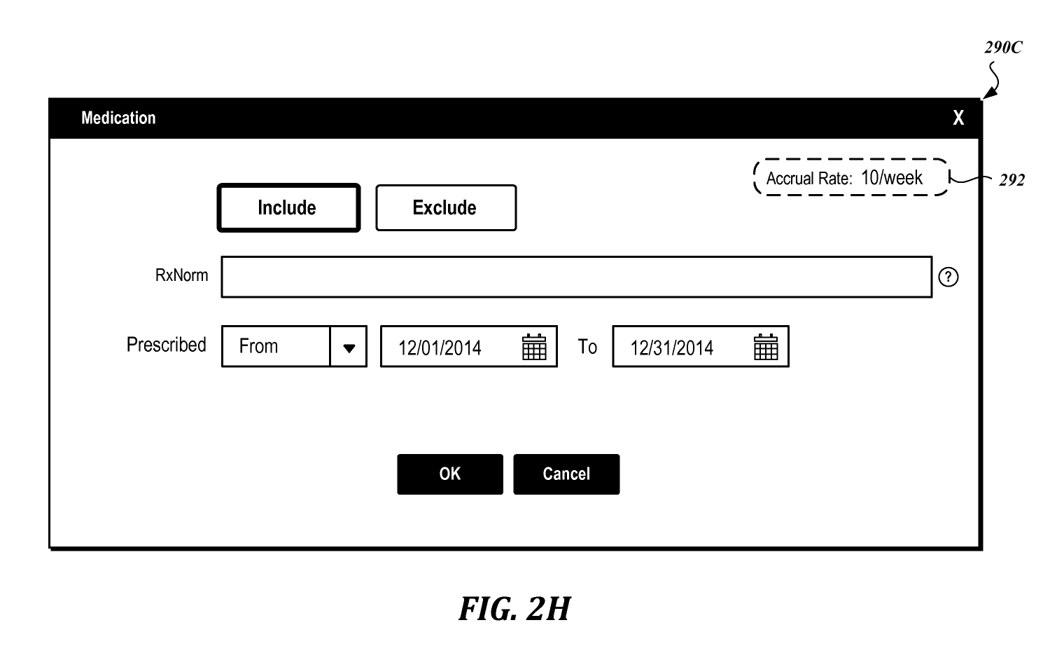

Cohorts are defined by one or more inclusion or exclusion criteria, such as demographics, specimen type, disease states, lab results, medications, and/or procedures. FIG. 2A is a screen shot of a cohort definition that may be presented in a user interface (e.g., a user interface provided by the requester portal 140). In this example, the cohort is being designed for a study on age-related type II diabetes, and defines a specimen type, demographics, lab results, comorbidities, medications, and procedures. FIG. 2B is a screen shot of an illustrative user interface 200 in which a similar cohort definition is provided in a cohort definition editor along with interactive elements that may be useful for editing an existing cohort definition or creating a new cohort definition, such as the “Submit,” “Save as Draft,” and “Cancel” buttons 210 shown within the dashed line. In the example shown in FIG. 2B, progress has already been made on collecting specimens, as indicated by the progress bar 204 and the percentage of specimens collected (55%). FIG. 2B also shows an estimated completion date, accrual rate, and estimated budget for the cohort, all of which can be calculated automatically, as described in detail below.

FIGS. 2C-2I are screen shots of illustrative user interfaces 290C-I that may be used (e.g., in combination with the elements of the user interface 200) to define specific inclusion or exclusion criteria for cohort definitions. FIG. 2C is a screen shot of a Specimen Type interface 290C in which details related to requested specimens can be entered (e.g., number of donors, specimen type, preparation, shipping options, etc.); FIG. 2D is a screen shot of a Demographic interface 290D in which details related to demographics can be entered (e.g., sex, age, race, geography, etc.); FIGS. 2E and 2F are screen shots of Lab Results interfaces 290E, 290F, in which details related to lab results can be entered (e.g., codes, test types, results, when the lab results were obtained, etc.); FIG. 2G is a screen shot of a Comorbidities interface 290G in which details related to comorbidities can be entered (e.g., codes, diagnosis dates, etc.); FIG. 2H is a screen shot of a Medication interface 290H in which details related to medications can be entered (e.g., codes, prescription dates, etc.); and FIG. 21 is a screen shot of a Procedure interface 2901 in which details related to procedures can be entered (e.g., codes, when the procedure was performed, etc.). As shown, the user interfaces 290C-I also include an accrual rate indicator 292, which can be used to present calculated accrual rate information for the particular cohort criterion being defined, or for an overall cohort definition of which the particular cohort criterion is a part. The accrual rate can be updated dynamically as criteria are added, removed, or edited. Illustrative techniques for calculating accrual rates are described in detail below.

### A. Decision Support Service

Although the user interfaces shown in FIGS. 2C-2I are useful for defining cohort criteria in some usage scenarios, such as where requesters are familiar with clinical coding standards, researchers may not always be familiar with such standards. Therefore, the cohort analytics platform can provide a decision support service to help users define a cohort that will match a real-world patient population. A decision support service provided by the cohort analytics platform may include one or more of the following features.

### 1. Terminology Search Suggestions

In this feature, a requester is presented with a search form in a user interface. In at least one embodiment, the requester begins typing an initial search term and receives a list of suggested searches based on lexical analysis techniques that are known in the art. Alternatively, the suggested searches can be provided on demand by the requester, such as by activating a button after an initial search term has been typed in.

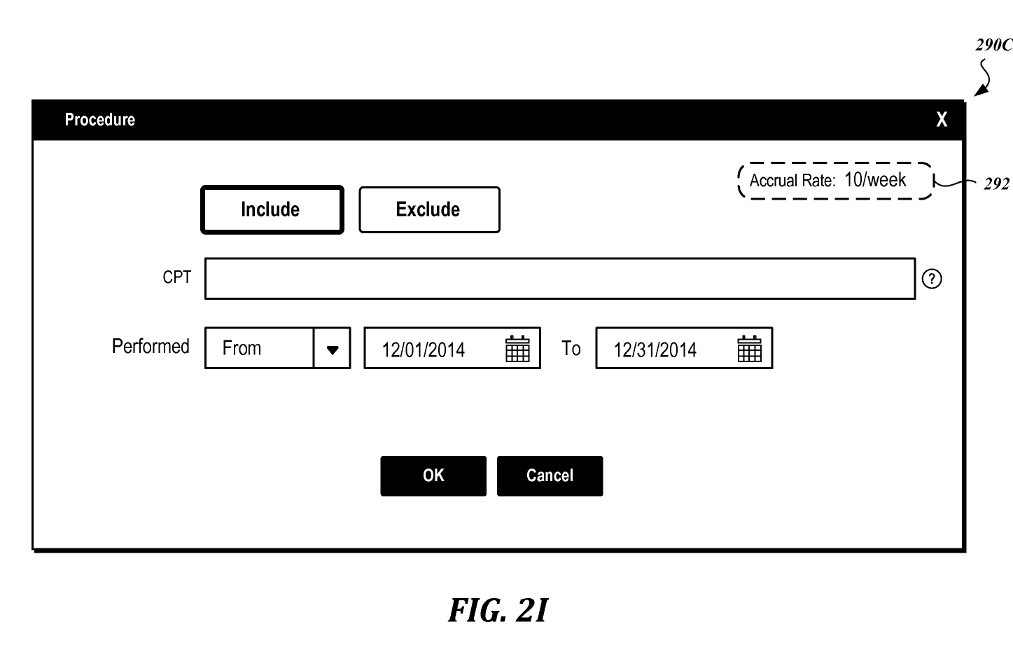

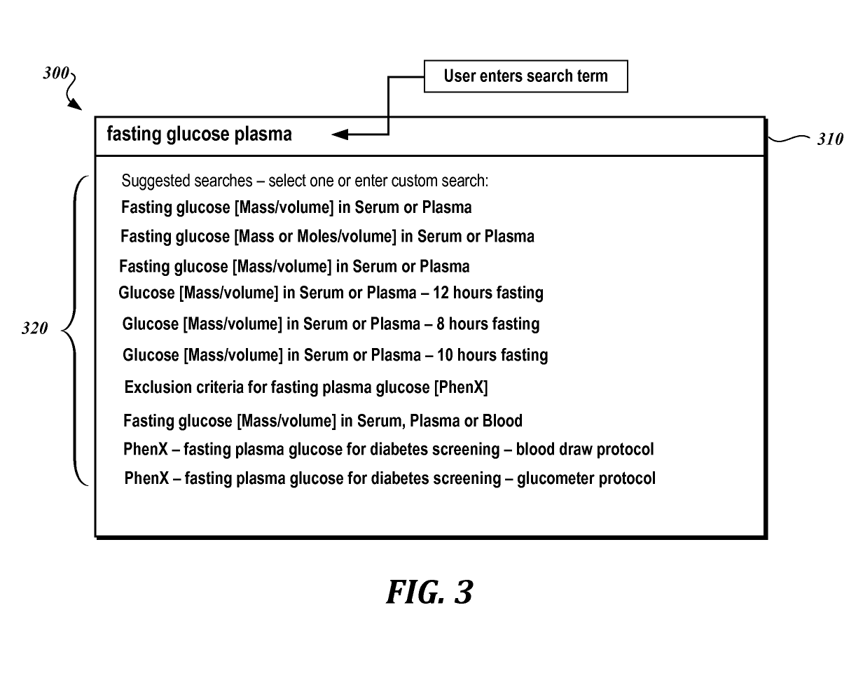

FIG. 3 is a screen shot of a search box that may be presented, for example, as part of the illustrative user interface 200. In this example, the requester provides text input representing a possible search term for a specimen into a text box 310, and in response the search box 300 presents a suggested cohort criterion search list 320. The requester may select one of the suggested searches (e.g., by clicking on or tapping an entry in the list 320) or use a custom search term (e.g., the specific term entered in the text box 310). The requester can then initiate a search based on the selected search term to see search results.

A similar process can be used for clinical terminologies related to lab results, comorbidities, medications, procedures, or any other search terms.

### 2. Terminology Search Results with Frequency Data

In this feature, search results are presented with frequency information. The frequency information may be provided in the form of a ranking of search results in order of most frequently used clinical codes. The frequency information also may include specific frequencies for the individual results. The frequency information may be calculated across multiple source sites, e.g., based on aggregated clinical data stored in the centralized data repository 110.

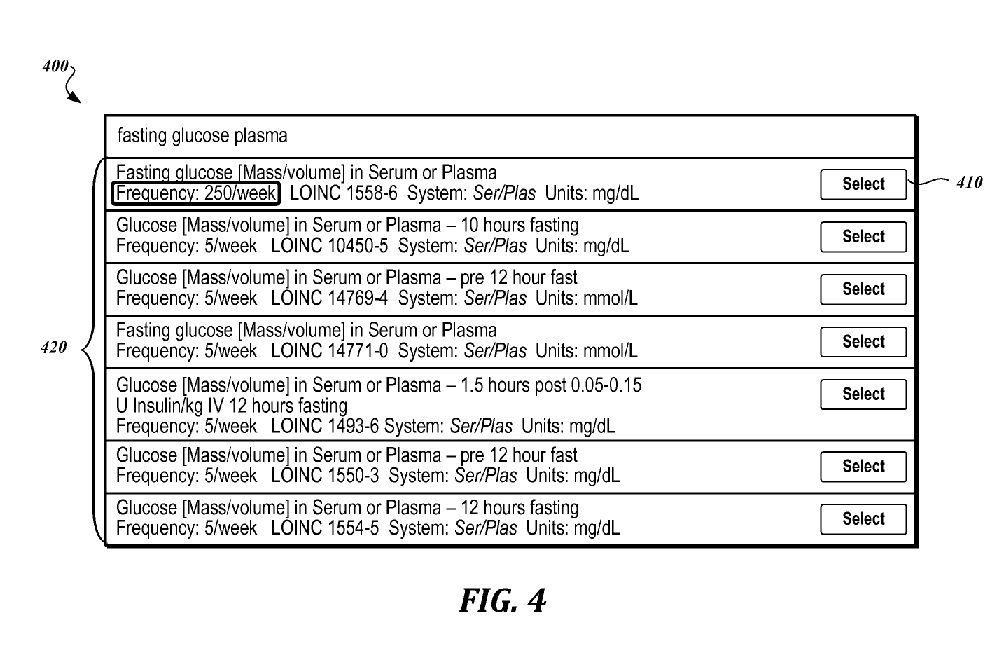

FIG. 4 is a screen shot of a search results interface 400 that may be presented, for example, as part of the illustrative user interface 200. In the example shown in FIG. 4, a researcher has requested a lab result for glucose level associated with a LOINC® code (promulgated by the Regenstrief Institute, Inc., and the Logical Observation Identifiers Names and Codes (LOINC) Committee). Currently, there are more than 20 clinical codes available to describe this. In at least one embodiment, the analytics platform calculates the frequency of individual search results in the centralized data repository 110, and presents ordered results with in-line frequency data to users. This can help users to select an appropriate result (e.g., the term most commonly used in the clinical setting), thereby allowing their cohort to match more real-world patient populations.

In the example shown in FIG. 4, the top result for the search (“fasting glucose plasma”) has a frequency of 250 occurrences per week. In the interactive results list 420, the frequency of the top result is highlighted (e.g., with a box around the frequency value) to draw attention to this fact. The requester may select one of the search results, e.g., by clicking on or tapping an entry in the interactive results list 420 or by activating a “select” button 410 within the entry.

A similar process can be used for lab results, comorbidities, medications, procedures, or any other search results.

### 3. Criteria Accrual Warnings

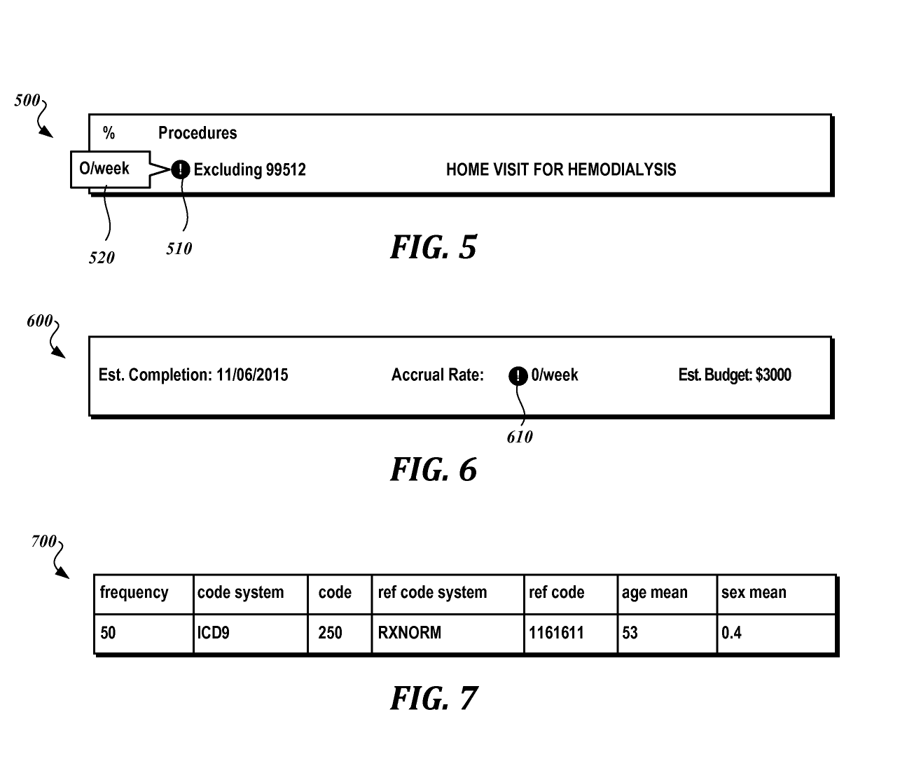

In this feature, problems with cohort criteria, such as low accrual rates, can be identified to help guide the cohort design. Individual criteria in the cohort with a low frequency may cause the cohort not to match any patients, or to match an insufficient number of patients to complete a project within a reasonable time or a specifically allotted time. FIG. 5 is a screen shot of a warning notification 500 that may be presented, for example, as part of the illustrative user interface 200. In the example shown in FIG. 5, the requester may be warned of such a condition via the information icon 510, which is shown to the left of the corresponding criterion in this example. The warning notification 500 also may include a pop-up or mouse-over feature 520 that shows the particular frequency measurement (e.g., 0 occurrences per week) that led to the warning condition.

### 4. Probability Density Function of Lab Results

In this feature, the cohort analytics platform includes functionality for analyzing lab test result ranges. In at least one embodiment, the cohort analytics platform can analyze the mean, variance, and standard deviation for each lab test result range, and calculate the probability that a future result will be in a range articulated by a cohort criterion using a probability density function. This calculation is a statistical calculation at the time it is presented to the user. Although batched, off-line database queries may be used to prepare such calculations, each individual calculation does not require a database query. Therefore, the cohort analytics platform can present meaningful results quickly, allowing the requester to iterate over multiple criteria definitions quickly until a working cohort has been created.

### B. Feasibility Analysis Service

As mentioned above, user interfaces associated with the cohort analytics platform may include elements that show information such as an estimated completion date, a projected accrual rate, and an estimated budget for a cohort, all of which can be calculated automatically. As a researcher designs her cohort, the cohort analytics platform can calculate a predicted accrual rate for all cohort criteria collectively and present this information to the researcher.

The projected accrual rate can be calculated by analyzing historic and current data to determine how many matches for individual criteria or combinations of criteria are expected (e.g., how many patient profiles are expected to match a cohort definition (or one or more criteria within the definition)) in a given time period (e.g., one week, one month, etc.). Patient profiles may be represented as data structures with fields corresponding to comment cohort criteria, such as comorbidities, sex, age, etc. If a cohort definition specifies female patients with type II diabetes between the ages of 30 and 35, the analytics platform can analyze historic and current data to determine how many patient profiles (which include information such as) match the cohort definition.

In an illustrative usage scenario, a researcher defines a matches-needed value to indicate how many matches are needed to complete a project or phase of a project. For example, if a project requires 500 patients to be identified for a particular clinical trial, the matches-needed value associated with the cohort definition would be 500. The projected accrual rate, combined with the matches-needed value, can be used to calculate the estimated completion date and the estimated budget to complete the project. The projected accrual rate can be updated after every change to cohort criteria.

FIG. 6 is a screen shot of cohort feasibility information 600 that may be presented, for example, as part of the illustrative user interface 200. In the example shown in FIG. 6, the requester may be warned of a low overall accrual rate via the information icon 610. The overall predicted accrual rate for a cohort can be calculated using statistical methods. In at least one embodiment, the following techniques are used.

First, if any required inclusion criteria have an accrual rate of 0 per week, then the overall cohort will have an accrual rate of 0 per week. In such a case, a warning can be presented to the requester, as shown in FIG. 6.

Second, if all required individual criteria have a frequency that is greater than 0, the analytics platform examines the aggregate historical frequency of all criteria in the cohort. For increased efficiency, frequencies of relationships between concurrent clinical terms (e.g., average periodic frequency of relationships) can be calculated and stored (e.g., by the cohort analytics platform or the centralized data repository 110). The analytics platform can then calculate a frequency for the cohort based on the frequencies of these relationships. For example, the analytics platform can use the lowest frequency among all cohort criteria relationships as the projected accrual rate for the cohort. Projected accrual rates can be weighted up or down depending on additional factors, such as age and sex requirements of the cohort.

After calculating a probability that two terms will appear concurrently, the projected accrual rate can be weighted up or down based on whether that relationship is more likely to be associated with a male or female, and depending on the cohort demographic criteria. FIG. 7 is a table 700 illustrating a pre-calculated concurrent clinical term relationship between a diabetes comorbidity (ICD9 code 250) and a metformin prescription (RxNORM code 1161611), with age mean (53) and sex mean (0.4) information also included for possible weighting of projected accrual rates. (The “sex mean” value of 0.4 indicates that approximately 60% of the patients associated with this relationship are female, and approximately 40% are male.)

For example, if the diabetes comorbidity/metformin prescription relationship shown in FIG. 7 has an accrual rate of 10 per week for both sexes, and a cohort seeks to identify such patients that are female, this weekly accrual rate can be weighted to provide a sex-specific accrual rate as follows: 10*(0.6)=6 per week.

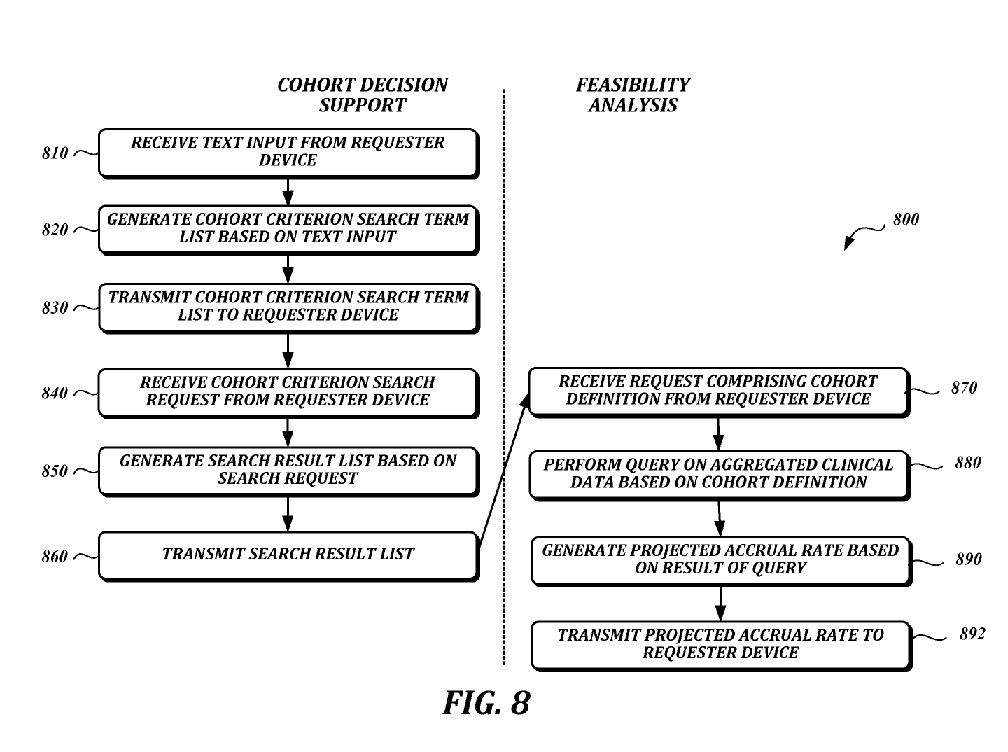

FIG. 8 is a flow chart illustrating a computer-implemented method 800 according to an embodiment of the present disclosure. The illustrative method 800 is performed by a computer system (e.g., the computer system 100 shown in FIG. 1) that hosts a cohort analytics platform. As shown in FIG. 8, steps 810-860 relate to a decision support service of the cohort analytics platform, and steps 870-892 relate to a feasibility analysis service of the cohort analytics platform.

At step 810, the computer system receives text input (e.g., via a search box 300 (FIG. 3) provided by the requester portal 140 (FIG. 1)) from a requester device (e.g., requester computing device 160 (FIG. 1)). The computer system generates a cohort criterion search term list at step 820 based at least in part on the text input, and transmits the cohort criterion search term list to the requester device (e.g., via the search box 300 provided by the requester portal 140) at step 830. The computer system receives (e.g., via a search results interface 400 (FIG. 4) provided by the requester portal 140) a cohort criterion search request from the requester device at step 840, generates a search result list based on the search request at step 850, and transmits the search result list to the requester device at step 860. The search result list may be presented, for example, in the search results interface 400. In this example, the search result list is ordered by accrual rate.

At step 870, the computer system receives (e.g., via a cohort definition editor provided by the requester portal 140) a request comprising a cohort definition from the requester device. The computer system performs a query on aggregated clinical data based on the cohort definition at step 880, generates a projected accrual rate based on a result of the query at step 890, and transmits the projected accrual rate to the requester device at step 892. The projected accrual rate may be presented, for example, in a user interface 200 (FIG. 2B) provided by the requester portal 140. The projected accrual rate can be updated dynamically as criteria are added, removed, or edited in the cohort definition.

Many alternatives to the illustrative method 800 are possible. For example, some functionality that is described as being provided by the computer system 100 may instead be provided by a suitably programmed requester device. Such functionality may include the ability to generate search term lists based on text input, or to generate search results based on a search request. In such scenarios, the transmission steps (e.g., steps 830 and 860) can be omitted, among other possible changes to the method 800.

### Illustrative Devices and Operating Environments

Unless otherwise specified in the context of specific examples, described techniques and tools may be implemented by any suitable computing device or set of devices.

In any of the described examples, a data store (e.g., a data source or repository described herein) may be hosted, for example, by a database management system (DBMS) to allow a high level of data throughput between the data repository and other components of a described system. The DBMS may also allow the data store to be reliably backed up and to maintain a high level of availability. For example, a data store may be accessed by other system components via a network, such as a private network in the vicinity of the system, a secured transmission channel over the public Internet, a combination of private and public networks, and the like. Instead of or in addition to a DBMS, a data store may include structured data stored as files in a traditional file system. Data stores may reside on computing devices that are part of or separate from components of systems described herein. Separate data stores may be combined into a single data store, or a single data store may be split into two or more separate data stores.

Some of the functionality described herein may be implemented in the context of a client-server relationship. In this context, server devices may include suitable computing devices configured to provide information and/or services described herein. Server devices may include any suitable computing devices, such as dedicated server devices. Server functionality provided by server devices may, in some cases, be provided by software (e.g., virtualized computing instances or application objects) executing on a computing device that is not a dedicated server device. The term “client” can be used to refer to a computing device that obtains information and/or accesses services provided by a server over a communication link. However, the designation of a particular device as a client device does not necessarily require the presence of a server. At various times, a single device may act as a server, a client, or both a server and a client, depending on context and configuration. Actual physical locations of clients and servers are not necessarily important, but the locations can be described as “local” for a client and “remote” for a server to illustrate a common usage scenario in which a client is receiving information provided by a server at a remote location. Alternatively, a peer-to-peer arrangement, or other models, can be used for transfer and processing of data.

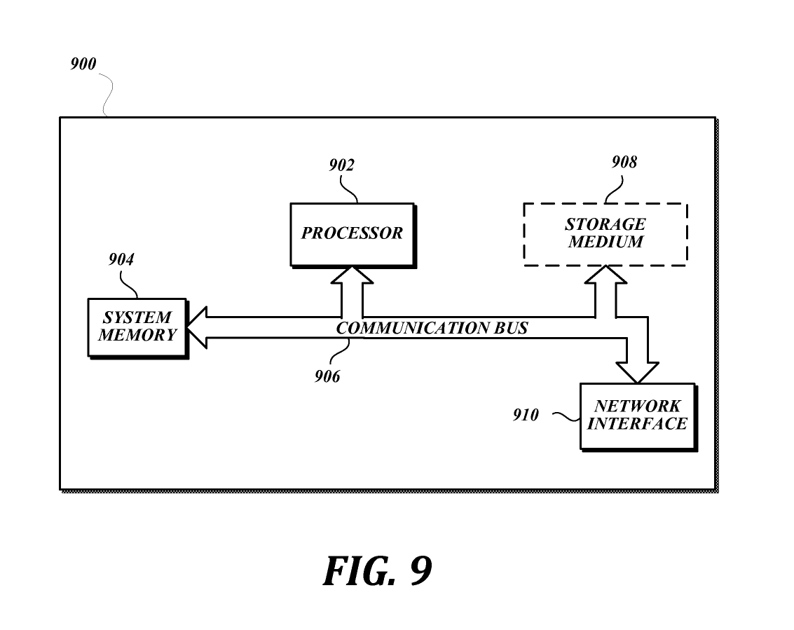

FIG. 9 is a block diagram that illustrates aspects of an illustrative computing device 900 appropriate for use in accordance with embodiments of the present disclosure. The description below is applicable to servers, personal computers, mobile phones, smart phones, tablet computers, embedded computing devices, and other currently available or yet-to-be-developed devices that may be used in accordance with embodiments of the present disclosure.

In its most basic configuration, the computing device 900 includes at least one processor 902 and a system memory 904 connected by a communication bus 906. Depending on the exact configuration and type of device, the system memory 904 may be volatile or nonvolatile memory, such as read only memory (“ROM”), random access memory (“RAM”), EEPROM, flash memory, or other memory technology. Those of ordinary skill in the art and others will recognize that system memory 904 typically stores data and/or program modules that are immediately accessible to and/or currently being operated on by the processor 902. In this regard, the processor 902 may serve as a computational center of the computing device 900 by supporting the execution of instructions.

As further illustrated in FIG. 9, the computing device 900 may include a network interface 910 comprising one or more components for communicating with other devices over a network. Embodiments of the present disclosure may access basic services that utilize the network interface 910 to perform communications using common network protocols. The network interface 910 may also include a wireless network interface configured to communicate via one or more wireless communication protocols, such as WiFi, 2G, 3G, 4G, LTE, WiMAX, Bluetooth, and/or the like.

In the illustrative embodiment depicted in FIG. 9, the computing device 900 also includes a storage medium 908. However, services may be accessed using a computing device that does not include means for persisting data to a local storage medium. Therefore, the storage medium 908 depicted in FIG. 9 is optional. In any event, the storage medium 908 may be volatile or nonvolatile, removable or nonremovable, implemented using any technology capable of storing information such as, but not limited to, a hard drive, solid state drive, CD-ROM, DVD, or other disk storage, magnetic tape, magnetic disk storage, and/or the like.

As used herein, the term “computer-readable medium” includes volatile and nonvolatile and removable and nonremovable media implemented in any method or technology capable of storing information, such as computer-readable instructions, data structures, program modules, or other data. In this regard, the system memory 904 and storage medium 908 depicted in FIG. 9 are examples of computer-readable media.

For ease of illustration and because it is not important for an understanding of the claimed subject matter, FIG. 9 does not show some of the typical components of many computing devices. In this regard, the computing device 900 may include input devices, such as a keyboard, keypad, mouse, trackball, microphone, video camera, touchpad, touchscreen, electronic pen, stylus, and/or the like. Such input devices may be coupled to the computing device 900 by wired or wireless connections including RF, infrared, serial, parallel, Bluetooth, USB, or other suitable connection protocols using wireless or physical connections.

In any of the described examples, input data can be captured by input devices and processed, transmitted, or stored (e.g., for future processing). The processing may include encoding data streams, which can be subsequently decoded for presentation by output devices. Media data can be captured by multimedia input devices and stored by saving media data streams as files on a computer-readable storage medium (e.g., in memory or persistent storage on a client device, server, administrator device, or some other device). Input devices can be separate from and communicatively coupled to computing device 900 (e.g., a client device), or can be integral components of the computing device 900. In some embodiments, multiple input devices may be combined into a single, multifunction input device (e.g., a video camera with an integrated microphone). The computing device 900 may also include output devices such as a display, speakers, printer, etc. The output devices may include video output devices such as a display or touchscreen. The output devices also may include audio output devices such as external speakers or earphones. The output devices can be separate from and communicatively coupled to the computing device 900, or can be integral components of the computing device 900. Input functionality and output functionality may be integrated into the same input/output device (e.g., a touchscreen). Any suitable input device, output device, or combined input/output device either currently known or developed in the future may be used with described systems.

In general, functionality of computing devices described herein may be implemented in computing logic embodied in hardware or software instructions, which can be written in a programming language, such as C, C++, COBOL, JAVA™, PHP, Perl, Python, Ruby, HTML, CSS, JavaScript, VBScript, ASPX, Microsoft .NET™ languages such as C#, and/or the like. Computing logic may be compiled into executable programs or written in interpreted programming languages. Generally, functionality described herein can be implemented as logic modules that can be duplicated to provide greater processing capability, merged with other modules, or divided into sub-modules. The computing logic can be stored in any type of computer-readable medium (e.g., a non-transitory medium such as a memory or storage medium) or computer storage device and be stored on and executed by one or more general-purpose or special-purpose processors, thus creating a special-purpose computing device configured to provide functionality described herein.

### Extensions and Alternatives

Many alternatives to the systems and devices described herein are possible. For example, individual modules or subsystems can be separated into additional modules or subsystems or combined into fewer modules or subsystems. As another example, modules or subsystems can be omitted or supplemented with other modules or subsystems. As another example, functions that are indicated as being performed by a particular device, module, or subsystem may instead be performed by one or more other devices, modules, or subsystems. Although some examples in the present disclosure include descriptions of devices comprising specific hardware components in specific arrangements, techniques and tools described herein can be modified to accommodate different hardware components, combinations, or arrangements. Further, although some examples in the present disclosure include descriptions of specific usage scenarios, techniques and tools described herein can be modified to accommodate different usage scenarios. Functionality that is described as being implemented in software can instead be implemented in hardware, or vice versa.

Many alternatives to the techniques described herein are possible. For example, processing stages in the various techniques can be separated into additional stages or combined into fewer stages. As another example, processing stages in the various techniques can be omitted or supplemented with other techniques or processing stages. As another example, processing stages that are described as occurring in a particular order can instead occur in a different order. As another example, processing stages that are described as being performed in a series of steps may instead be handled in a parallel fashion, with multiple modules or software processes concurrently handling one or more of the illustrated processing stages. As another example, processing stages that are indicated as being performed by a particular device or module may instead be performed by one or more other devices or modules.

Many alternatives to the user interfaces described herein are possible. In practice, the user interfaces described herein may be implemented as separate user interfaces or as different states of the same user interface, and the different states can be presented in response to different events, e.g., user input events. The user interfaces can be customized for different devices, input and output capabilities, and the like. For example, the user interfaces can be presented in different ways depending on display size, display orientation, whether the device is a mobile device, etc. The information and user interface elements shown in the user interfaces can be modified, supplemented, or replaced with other elements in various possible implementations. For example, various combinations of graphical user interface elements including text boxes, sliders, drop-down menus, radio buttons, soft buttons, etc., or any other user interface elements, including hardware elements such as buttons, switches, scroll wheels, microphones, cameras, etc., may be used to accept user input in various forms. As another example, the user interface elements that are used in a particular implementation or configuration may depend on whether a device has particular input and/or output capabilities (e.g., a touchscreen). Information and user interface elements can be presented in different spatial, logical, and temporal arrangements in various possible implementations. For example, information or user interface elements depicted as being presented simultaneously on a single page or tab may also be presented at different times, on different pages or tabs, etc. As another example, some information or user interface elements may be presented conditionally depending on previous input, user preferences, or the like.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the claimed subject matter.

The embodiments of the invention in which an exclusive property or privilege is claimed are defined as follows:

1. A computer-implemented method comprising:
by a computer system, receiving a request from a requester computing device, wherein the request comprises a cohort definition;
by the computer system, performing a query on a centralized data repository comprising clinical data aggregated from a plurality of remote clinical data sources, wherein the query is based at least in part on the cohort definition;
by the computer system, generating a projected accrual rate based at least in part on a result of the query; and
by the computer system, transmitting the projected accrual rate to the requester computing device for presentation in a user interface of the requester computing device.

2. The method of claim 1, wherein the request further comprises a matches-needed value.

3. The method of claim 2, further comprising generating a projected completion date based at least in part on the projected accrual rate and the matches-needed value.

4. The method of claim 1, wherein generating the projected accrual rate comprises determining a projected accrual rate for a concurrent clinical term relationship in the cohort definition.

5. The method of claim 4, wherein generating the projected accrual rate further comprises weighting the projected accrual rate for the concurrent clinical term relationship based on an age or sex requirement in the cohort definition.

6. The method of claim 1, wherein the aggregated clinical data is pre-filtered based on patient consent.

7. A computer-implemented method comprising:
by a computer system, receiving a cohort criterion search request;
by the computer system, generating a list of search results based on the cohort criterion search request; and
by the computer system, providing the list of search results in a user interface, wherein the list of search results is ordered by accrual rate.

8. The method of claim 7, further comprising:
receiving text input;
generating a cohort criterion search term list based on the text input; and
providing the cohort criterion search term list in the user interface.

9. The method of claim 7, wherein the computer system hosts a centralized data repository that includes clinical data aggregated from multiple remote data sources.

10. The method of claim 9, wherein said generating the list of search results is further based on a query on the aggregated clinical data.

11. The method of claim 9, wherein the aggregated clinical data is pre-filtered based on patient consent.

12. A computer system comprising one or more computers programmed to:
communicate with a plurality of requester computing devices;
host a centralized data repository that includes clinical data aggregated from multiple remote data sources; and
host a cohort analytics platform configured to:
receive requests from the requester computing devices, wherein the requests comprise cohort definitions;
perform queries on the aggregated clinical data based at least in part on the cohort definitions;
generate projected accrual rates based at least in part on results of the queries on the aggregated clinical data; and
transmit the projected accrual rates to the respective requester computing devices for presentation in user interfaces of the respective requester computing devices.

13. The computer system of claim 12, wherein the requests further comprise matches-needed values.

14. The computer system of claim 13, wherein the cohort analytics platform is further configured to generate projected completion dates based at least in part on the projected accrual rates and the matches-needed values.

15. The computer system of claim 13, wherein the projected accrual rates are based at least in part on projected accrual rates for concurrent clinical term relationships in the cohort definition.

16. The computer system of claim 15, wherein at least some of the projected accrual rates for the concurrent clinical term relationships are weighted based on age or sex requirements in the cohort definitions.

17. The computer system of claim 12, wherein the cohort analytics platform is further configured to:
receive cohort criterion search requests from the requester computing devices;
generate lists of search results based on the cohort criterion search requests; and
transmit the lists of search results to the respective requester computing devices, wherein the lists of search results are ordered by accrual rate.

18. The computer system of claim 12, wherein the lists of search results ordered by accrual rate are further based on queries on the aggregated clinical data.

19. The computer system of claim 12, wherein the cohort analytics platform is further configured to:
receive text input from the requester computing devices;
generate cohort criterion search term lists based on the text input; and
transmit the cohort criterion search term lists to the respective requester computing devices.

20. The computer system of claim 12, wherein the aggregated clinical data is pre-filtered based on patient consent.

21. The computer system of claim 12, wherein the one or more computers are further programmed to host a fulfillment platform.
